(19) United States
(12) Patent Application Publication
(10) Pub. No.: US 2016/0062952 A1
(43) Pub. Date: Mar. 3, 2016

(54) MEASUREMENT PRECISION EVAULATION DEVICE, METHOD, AND COMPUTABLE READABLE MEDIUM

(71) Applicant: Science Software Co., Ltd., Tokyo (JP)

(72) Inventors: Yuzuru Hayashi, Chiba (JP); Nien Fan Zhang, Gaithersburg, MD (US)

(21) Appl. No.: 14/842,840

(22) Filed: Sep. 2, 2015

Related U.S. Application Data
(60) Provisional application No. 62/045,548, filed on Sep. 3, 2014.

(51) Int. Cl. G06F 17/18

(52) U.S. Cl. CPC G06F 17/18

(57) ABSTRACT

For a baseline of instrumental output containing a signal and noise considered to be a stationary process, a calculation section 22 calculates an autocorrelation function or an autocovariance function of the baseline, and a statistical quantity of the baseline, based on the baseline of the instrumental output. A precision evaluation section 24 evaluates the standard deviation or the variance of the measurement values based on the autocorrelation function or the autocovariance function of the baseline calculated by the calculation section 22, and the statistical quantity of the baseline. The precision of the measurement values of the instrumental output can thereby be evaluated with high precision.

### CROSS-REFERENCE TO RELATED APPLICATION

This application is based on and claims priority under 35 USC 119 from U.S. Patent Application No. 62/045,548 filed Sep. 3, 2014.

### TECHNICAL FIELD

The present invention relates to a measurement precision evaluation device, method, and computer readable medium.

### BACKGROUND ART

Precision or uncertainty is of great importance in every field of analytical chemistry to ensure the statistical reliability of measurements in analysis. The precision is usually expressed as the standard deviation (SD) or coefficient of variation (relative standard deviation) of the measurements. In many, if not most, instrumental analyses, baseline noise is considered to be the dominant source of uncertainty, especially if the sample concentration is near the detection limit. Many analysts have directed their efforts on the assessment of measurement precision toward establishing a theory for evaluating the precision of measurements from the background noise, which exists ubiquitously in analytical instruments whether or not a sample is being measured. Within its domain of applicability, the theory can dispense with the repetitive measurement of real samples, thus helping to improve the global environment by saving energy and material. The time and human efforts that would be required by the repetition may also be reduced. Recently, some theories (Alkemade, C. T. J., Snelleman. S., Boutilier, G. D., Pollard, B. D., Wineforder, J. D., Chester, T. L., and Omenetto, N. Spectrochima Acta. 1978, 33B, 383-399. G. D. Boutilier, B. D. Pollard, J. D. Winefordner, T. L. Chester, and N. Omenetto. Spectrochim. Acta. 1978, 33B, 401-415. C. Th. J. Alkemade, W. Snelleman, G. D. Boutilier, and J. D. Winefordner. Spectrochim. Acta. 1980, 35B, 261-270. Hayashi, Y. and Matsuda, R. Analytical Chemistry. 1994, 66(18), 2874-2881. Y. Hayashi, R. Matsuda, Chromatographia. 1995, 41:75-83. R. B. Poe, Y. Hayashi, R. Matsuda. Anal. Sci., 1997, 13:951-962.) for evaluating the instrumental uncertainty have been adopted as an ISO International Standard (ISO 11843-7 Capability of detection—Part 7: Methodology based on stochastic properties of instrumental noise. 2012, ISO.).

Background noise generally can be treated as random processes in probability theory and statistics. Then, these random processes can be grouped into two broad categories as stationary and non-stationary processes. Stationary processes are characterized by a constant, mean and standard deviation at every point in time. In contrast, as suggested by the name, non-stationary processes are processes with time-dependent means and/or standard deviations.

Although relatively simple compared to non-stationary processes, stationary processes are useful for modeling many practical situations. These include manufacturing processes, like those described by Box and Luceno (Box, B. and A. Statistical control by monitoring and feedback adjustment. Wiley: New York, 1997, 17-18.) and MacGregor and Harris (MacGregor, J. F.; Harris, T. J. Journal of Quality Technology. 1993, 25, 106-118.). Furthermore, mathematically well-defined stationary process models such as white noise and autoregressive (AR) processes have been shown to be applicable in practical situations where observed processes are assumed to be in a state of statistical equilibrium (Priestley, M. B. Spectral analysis and time series. Academic Press: London, 1981, 14-15 and 117.). Even when an observed time series seems to be non-stationary due to a long-term systematic trend or drift, its description in terms of a stationary process still may be valuable after the trend is eliminated (Zhang, N. F.; Postek, M. T.; Larrabee, R. D. Metrologia. 1997, 34, 467-477.) In addition to phenomena that can be modeled as purely stationary processes, a variety of natural phenomena can be formulated as 1/f noise. Applications range from biological observations, such as membrane potential of cells, to physical occurrences like electronic current of circuits. Many experiments reported in the literature demonstrate that the background noise in instrumental analysis is no exception (Ingle, J. D., Jr.; Crouch, S. R. Spectrochemical Analysis; Prentice Hall; Engleswood Cliff, N.J., 1988. Hayashi, Y. and Matsuda, R. Analytical Chemistry. 1994, 66(18), 2874-2881. Y. Hayashi, R. Matsuda, Chromatographia. 1995, 41:75-83. R. B. Poe, Y. Hayashi, R. Matsuda. Anal. Sci., 1997, 13:951-962. Smit, H. G.; Walg, H. L. Chromatographia. 1975, 3, 311. assart, D. L.; Vandeginste, B. G. M.; Deming, S. N.; Michotte, Y.; Kaufman, L. Chemometrics: a Textbook; Elsevier: Amsterdam, 1988.). The power spectrum, P(f), of 1/f noise has a slope inversely proportional to frequency, f, as

$$P ( f ) ∝ \frac{1}{f}$$

when f is near zero. Theoretically, 1/f noise is a non-stationary process, but in practice, 1/f noise can be treated as a limiting case of a class of stationary processes, i.e., stationary fractional difference processes (Zhang, N. F. Metrologia. 2008, 45, 549-561. Hoskin, J. R. M. Biometrika. 1981, 68, 165-176.). In addition, Hosking indicated that a stationary first order autoregressive-first order moving average (ARMA(1,1)) model can approximate 1/f noise (Hosking, J. R. M. Water Resources Research. 1984, 20, 1898-1908.) Theoretical approaches to quantifying measurement precision have been published in various areas of analytical chemistry (Ingle, J. D., Jr. Anal. Chem. 1974, 46, 2161-2171. Ingle, J. D., Jr.; Crouch, S. R. Spectrochemical Analysis; Prentice Hall; Engleswood Cliff, N.J., 1988. Boumans, P. W. J. M. Anal. Chem. 1994, 66, 459A-467A. Prudnikov, E. D.; Elgersma, J. W.; Smit., H. C. J. Anal. At. Spectrom. 1994, 9, 619-622. Alkemade, C. T. J., Snelleman. S., Boutilier, G. D., Pollard, B. D., Wineforder, J. D., Chester, T. L., and Omenetto, N. Spectrochima Acta. 1978, 33B, 383-399. G. D. Boutilier, B. D. Pollard, J. D. Winefordner, T. L. Chester, and N. Omenetto. Spectrochim. Acta. 1978, 33B, 401-415. C. Th. J. Alkemade, W. Snelleman, G. D. Boutilier, and J. D. Winefordner. Spectrochim. Acta. 1980, 35B, 261-270. Hayashi, Y. and Matsuda, R. Analytical Chemistry. 1994, 66(18), 2874-2881. Y. Hayashi, R. Matsuda, Chromatographia. 1995, 41:75-83. R. B. Poe, Y. Hayashi, R. Matsuda. Anal. Sci., 1997, 13:951-962. Matsuda, R.; Hayashi, Y.; Sasaki, K.; Saito, Y; Iwaki, K.; Harakawa, H.; Satoh, M.; Ishizuki, Y.; Kato, T. Anal. Chem. 1998, 70, 319-327.). However, the value of stationary random processes has only been explicitly referred to in a few publications (Alkemade, C. T. J., Snelleman. S., Boutilier, G. D., Pollard, B. D., Wineforder, J. D., Chester, T. L., and Omenetto, N. Spectrochima Acta. 1978, 33B, 383-399. Larsson, P. T.; Westlund, P-O.; Spectrochim. Acta A, 2005, 62, 539-546.) despite its theoretical and practical importance as discussed above. Assuming stationarity, Alkemade et al. developed a useful theory for assessing the measurement SD from baseline noise, but its applicability is restricted to simple measurements usually carried out in spectroscopy (see below). The Function of Mutual Information (FUMI) theory (Hayashi, Y. and Matsuda, R. Analytical Chemistry. 1994, 66(18), 2874-2881. Y. Hayashi, R. Matsuda, Chromatographia. 1995, 41:75-83. R. B. Poe, Y. Hayashi, R. Matsuda. Anal. Sci., 1997, 13:951-962. Matsuda, R.; Hayashi, Y.; Sasaki, K.; Saito, Y; Iwaki, K.; Harakawa, H.; Satoh, M.; Ishizuki, Y.; Kato, T. Anal. Chem. 1998, 70, 319-327.) has wider applicability in stationary situations, but was derived based on a non-stationary process.

### SUMMARY OF INVENTION

### Technical Problem

An object of the present invention is to provide a measurement precision evaluation device, method, and program that are capable of evaluating the precision of measurement values of instrumental output with high precision.

### Solution to Problem

In order to achieve the above object, a measurement precision evaluation device according to a first aspect, for a baseline of instrumental output containing a signal and noise considered to be a stationary process, evaluates a standard deviation or a variance of measurement values from the baseline. The measurement precision evaluation device includes: a calculation section that calculates an autocorrelation function or an autocovariance function of the baseline, and a statistical quantity of the baseline, based on the baseline of the instrumental output; and a precision evaluation section that evaluates the standard deviation or the variance of the measurement values based on the autocorrelation function or the autocovariance function of the baseline, and based on the statistical quantity of the baseline, which are calculated by the calculation section.

A measurement precision evaluation device according to a second aspect, for a baseline of instrumental output including a signal and noise considered to be a random process combining white noise and a first order autoregressive process, evaluates the standard deviation or variance of measurement values from the baseline. The measurement precision evaluation device includes: a calculation section that uses an autocorrelation function or an autocovariance function of the baseline to calculate a parameter representing the strength of autocorrelation of the first order autoregressive process, the variance of the first order autoregressive process, and the variance of the white noise, based on the baseline of the instrumental output; and a precision evaluation section that evaluates the standard deviation or the variance of the measurement values based on the parameter, the variance of the first order autoregressive process, and the variance of the white noise which are calculated by the calculation section.

A measurement precision evaluation method according to a third aspect, for a baseline of instrumental output including a signal and noise considered to be a stationary process, evaluates the standard deviation or variance of measurement values from the baseline. The measurement precision evaluation method comprising: calculating an autocorrelation function or autocovariance function of the baseline, and a statistical quantity of the baseline, based on the instrumental output; and evaluating the standard deviation or the variance of the measurement values based on the calculated autocorrelation function or the calculated autocovariance function of the baseline, and the calculated statistical quantity of the baseline.

A measurement precision evaluation method according to a fourth aspect, for a baseline of instrumental output including a signal and noise considered to be a random process combining white noise and a first order autoregressive process, evaluates the standard deviation or variance of measurement values from the baseline. The measurement precision evaluation method comprising: using an autocorrelation function or an autocovariance function of the baseline, calculating a parameter representing the strength of autocorrelation of the first order autoregressive process, the variance of the first order autoregressive process, and the variance of the white noise, based on the baseline of the instrumental output; and evaluating the standard deviation or the variance of the measurement values based on the calculated parameter, the calculated variance of the first order autoregressive process, and the calculated variance of the white noise.

A program according to a fifth aspect is a program causing a computer to execute a process. The process includes: for a baseline of instrumental output including a signal and noise considered to be a stationary process, calculating an autocorrelation function or autocovariance function of the baseline, and a statistical quantity of the baseline, based on the baseline of the instrumental output; and evaluating the standard deviation or the variance of the measurement values based on the calculated autocorrelation function or the calculated autocovariance function of the baseline, and the calculated statistical quantity of the baseline.

A program according to a sixth aspect is a program causing a computer to execute a process. The process includes: for a baseline of instrumental output including a signal and noise considered to be a random process combining white noise and a first order autoregressive process, calculating a parameter representing the strength of autocorrelation of the first order autoregressive process, the variance of the first order autoregressive process, and the variance of the white noise, based on the baseline of the instrumental output, using an autocorrelation function or an autocovariance function of the baseline; and evaluating the standard deviation or the variance of the measurement values based on the calculated parameter, the calculated variance of the first order autoregressive process, and the calculated variance of the white noise.

### Advantageous Effects of Invention

As explained above, a measurement precision evaluation device according to an aspect of the present invention enables precision of measurement values of instrumental output to be evaluated with the high precision.

### BRIEF DESCRIPTION OF DRAWINGS

FIG. 1A is a graph illustrating baseline noise.

FIG. 1B is a graph illustrating baseline noise.

FIG. 2 is a block diagram illustrating a functional configuration of a measurement precision evaluation device according to an exemplary embodiment of the present invention.

FIG. 3 is a flowchart diagram illustrating a measurement precision evaluation processing routine of a measurement precision evaluation device according to a first exemplary embodiment of the present invention.

FIG. 4 is a flowchart diagram illustrating a measurement precision evaluation processing routine of a measurement precision evaluation device according to a second exemplary embodiment of the present invention.

FIG. 5 is a graph illustrating baseline noise.

FIG. 6 is a diagram illustrating experimental results.

FIG. 7 is a graph illustrating a calculated result for an autocorrelation function.

### DESCRIPTION OF EMBODIMENTS

Detailed explanation follows regarding exemplary embodiments of the present invention, with reference to the drawings

Outline of First Exemplary Embodiment of Invention

The present exemplary embodiment proposes an approach for evaluating measurement precision in instrumental analyses under the assumption of stationarity. The approach is a general theory developed without any more assumptions than those required of a stationary process. Consequently, the approach can cover the work by Alkemade et al (Alkemade, C. T. J., Snelleman. S., Boutilier, G. D., Pollard, B. D., Wineforder, J. D., Chester, T. L., and Omenetto, N. Spectrochima Acta. 1978, 33B, 383-399. G. D. Boutilier, B. D. Pollard, J. D. Winefordner, T. L. Chester, and N. Omenetto. Spectrochim. Acta. 1978, 33B, 401-415. C. Th. J. Alkemade, W. Snelleman, G. D. Boutilier, and J. D. Winefordner. Spectrochim. Acta. 1980, 35B, 261-270.).

Basic Model for Noise and Error

Throughout the present exemplary embodiment, the baseline noise is assumed to be the only source of measurement error. First, we clarify the meaning of noise, signal and measurement in a mathematical sense and finally derive two equations to describe the measurement precision based on these concepts (see equations (2) and (13)).

In the measurement model adopted here, a signal, usually peak-shaped, is assumed to be invariable in every repetition experiment conducted under exactly the same conditions, whereas the baseline noise is treated as a discrete stationary process. The signal is added at each data point to the random baseline noise, constituting instrumental output Y(t) at time t such as chromatogram or spectrum (Hayashi, Y. and Matsuda, R. Analytical Chemistry. 1994, 66(18), 2874-2881.). A measurement is defined as an observed height or area of the noisy output Y(t) over a part or entire region of the signal. The repetition of this measurement forms an ensemble of measurements, from which the variance of the measurements is calculated.

In this model where the signal is constant at every repetition and the measurement error comes from the baseline noise alone, the variance of height or area measurements coincides with the variance of measurements over the baseline noise without the signal. Hereinafter, Y(t) represents the background noise without signal, as far as the measurement uncertainty is concerned.

The above coincidence of the measurement variance and error variance must be ensured by the condition that the stochastic properties of the noise are invariable irrespective of the existence of signal. In atomic absorption spectrometry, however, the noise properties have been observed to vary according to the signal intensity (i.e., sample amount) (Matsuda, R.; Hayashi, Y.; Sasaki, K.; Saito, Y; Iwaki, K.; Harakawa, H.; Satoh, M.; Ishizuki, Y.; Kato, T. Anal. Chem. 1998, 70, 319-327.) In this situation, additional modeling is required for theoretical evaluation of the uncertainty and such models are beyond the scope of the present exemplary embodiment.

A time series is regarded as being stationary if it is in a state of “statistical equilibrium.” (Priestley, M. B. Spectral analysis and time series. Academic Press: London, 1981, 14-15 and 117.) Namely, the stochastically fundamental behavior of the time series does not change in the course of time. Mathematically, a discrete time series, Y(t) (t=0, 1, . . . ), is (weakly) stationary, if the following conditions are met:
1. the mean is finite and constant for every t: E[Y(t)]=μ;
2. the variance is finite and constant for every t: Var[Y(t)]=σ_{Y}²<∞;
3. the covariance, Cov[Y(t), Y(t+r)] (=E[(Y(t)−μ)(Y(t+τ)−μ)]), depends only on the lag τ.

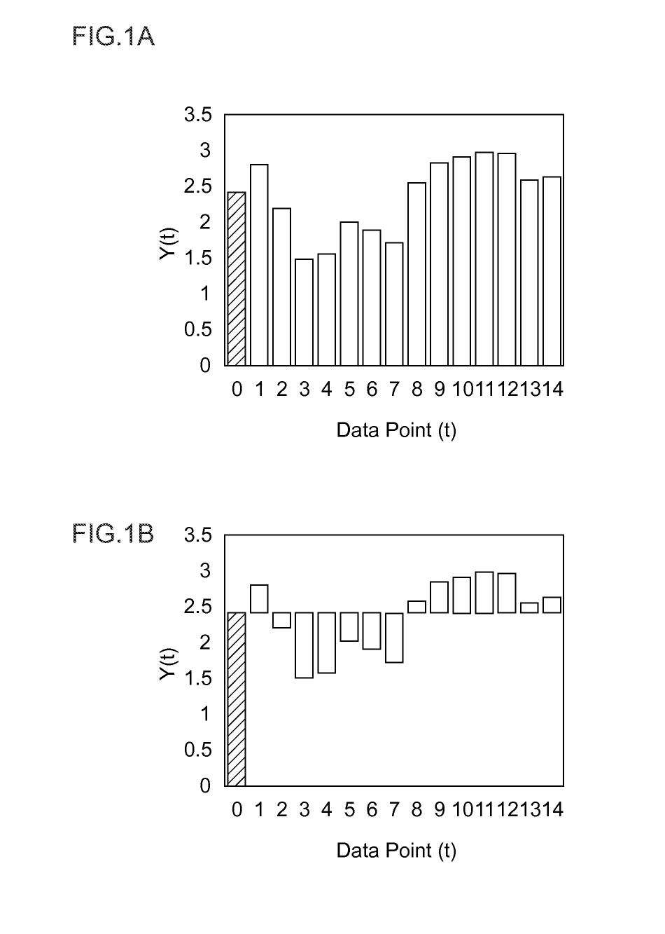

As discussed above, in the models under consideration here, a measurement over the noise without the signal is equivalent to the measurement error when a signal is present. Here, the measurement error, called the relative area, is defined as

$${A}_{c} ( k ) = [ {\sum }_{t = 1}^{k} Y ( t ) ] - kY ( 0 ) , \qquad ( 1 )$$

where Y(t) denotes the baseline noise and the range from 1 to k covers the signal region for the error estimation. The second term, kY(0) is necessary for handling real data as handled by many data processors of analytical instruments especially in chromatography; i.e., noise-created area, A_{c}(k) is relative to the zero level, Y(0) (see below and also FIG. 1).

FIGS. 1A and 1B simulate the baseline noise of an instrument, Y(t). A signal, though not shown in FIGS. 1A and 1B, is supposed to appear in the region from t=1 to 14. In a real analysis, therefore, another observation would need to be carried out to estimate the signal region. The first term on the right side of equation (1) which is illustrated by FIG. 1A is not used as a measurement (error) in real situations, since a long-term noise, often called drift, can deviate the “baseline” far away from the absolute zero as shown in FIG. 1A, overestimating the real signal shape (area or height).

Analysts usually take a zero level to circumvent the above problem. Here, the intensity, Y(0), of the preceding point (t=0) is set as the zero level as shown in FIG. 1B. We can see that the relative area (FIG. 1B) is practically favorable as compared to the absolute area (FIG. 1A). Alkemade et al. (Alkemade, C. T. J., Snelleman. S., Boutilier, G. D., Pollard, B. D., Wineforder, J. D., Chester, T. L., and Omenetto, N. Spectrochima Acta. 1978, 33B, 383-399.) also uses the concept of the relative area by adopting the difference in intensity between two points, Y(t)-Y(0) as a measurement, which is called a signal reading corrected for background.

Measurement Precision for a Stationary Process

The variance of A_{c}(k) in equation (1) represents the measurement precision originating from a stationary background noise as:

$$Var [ {A}_{c} ( k ) ] = [ k + {k}^{2} - 2 {{\sum }^{k}}_{i = 1} i {ρ}_{Y} ( i ) ] {σ}_{Y}^{2} , \qquad ( 2 )$$

where σ_{Y}² denotes the variance of Y(t) and ρ_{Y}(i) is the process autocorrelation at lag i (ρ_{Y}(i)=Cov[Y(t), Y(t+i)]/σ_{Y}²). Equation (2) demonstrates that given ρ_{Y}(i) (i=1, . . . , k) and σ_{Y}², the variance of a measurement made when signal is present, Var[A_{c}(k)], can be calculated. The stationarity of A_{c}(k) is ensured by the stationarity of Y(t) (see the above conditions 1-3).

Equation (2) is a general theory based solely on the stationary process. It includes, as a special case, the theory by Alkemade et al. for the uncertainty of the signal reading corrected for background, Y(t)-Y(0), if the measurement (equation (1)) is restricted to just two points.

Derivation of Equation (2)

Equation (2) can be expanded as follows:

$$\begin{matrix}Var [ {A}_{c} ( k ) ] = Var [ {\sum }_{i = 1}^{k} Y ( i ) - kY ( 0 ) ] \\ = Var [ {\sum }_{i = 1}^{k} Y ( i ) ] + {k}^{2} {σ}_{Y}^{2} - 2 k {σ}_{Y}^{2} {\sum }_{i = 1}^{k} {ρ}_{Y} ( i ) \\ = [ k + 2 {\sum }_{i = 1}^{k - 1} ( k - i ) {ρ}_{Y} ( i ) ] {σ}_{Y}^{2} + {k}^{2} {σ}_{Y}^{2} - 2 k {σ}_{Y}^{2} {\sum }_{i = 1}^{k} {ρ}_{Y} ( i ) \\ = [ k + {k}^{2} - 2 {\sum }_{i = 1}^{k} i {ρ}_{Y} ( i ) ] {σ}_{Y}^{2} .\end{matrix} \qquad ( A .1 )$$

The definitions of ρ_{Y}(i) and σ_{Y}² are given in equation (2). The right side of the third equality of equation (A.1) can be derived based on equation (4) of reference (Zhang, N. F. Metrologia. 2006, 43, S276-S281.).

Configuration of Measurement Precision Evaluation Device According to First Exemplary Embodiment

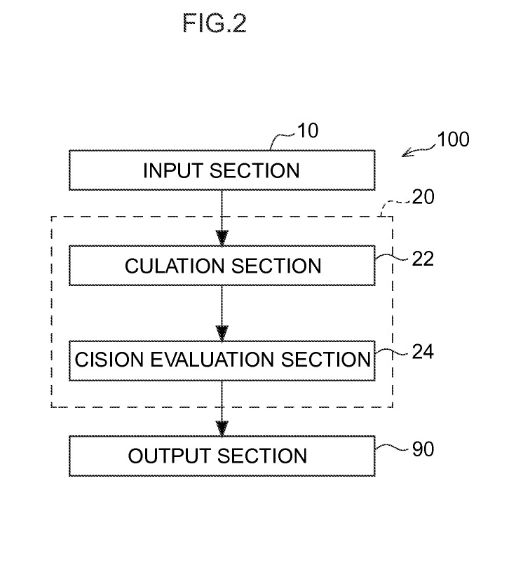

Explanation next follows regarding configuration of a measurement precision evaluation device according to a first exemplary embodiment. As illustrated in FIG. 2, a measurement precision evaluation device 100 according to the first exemplary embodiment may be configured by a computer including a CPU, RAM, and ROM storing a program for executing a measurement precision evaluation processing routine described below, and various data. The measurement precision evaluation device 100 includes an input section 10, an arithmetic section 20, and an output section 90 as functionally illustrated in FIG. 2.

The input section 10 receives the baseline of instrumental output.

The arithmetic section 20 is configured including a calculation section 22 and a precision evaluation section 24.

The calculation section 22 calculates an variance σ_{Y}² of the baseline Y(t) based on a baseline Y(t) of the instrumental output received by the input section 10. The calculation section 22 also calculates an autocorrelation ρ_{Y}(i) (i=1, . . . , k) of the baseline at lag i, according to the following equation.

ρ_{Y}(i)=Cov[Y(t),Y(t+i)]/σ_{Y}²

The precision evaluation section 24 evaluates the variance Var[A_{c}(k)] of the measurement values based on the autocorrelation function ρ_{Y}(i) of the baseline calculated by the calculation section 22, and the variance σ_{Y}² of the baseline, according to Equation (2) above.

The variance Var[A_{c}(k)] of the measurement values evaluated by the precision evaluation section 24 is output by the output section 90.

Operation of Measurement Precision Evaluation Device According to First Exemplary Embodiment

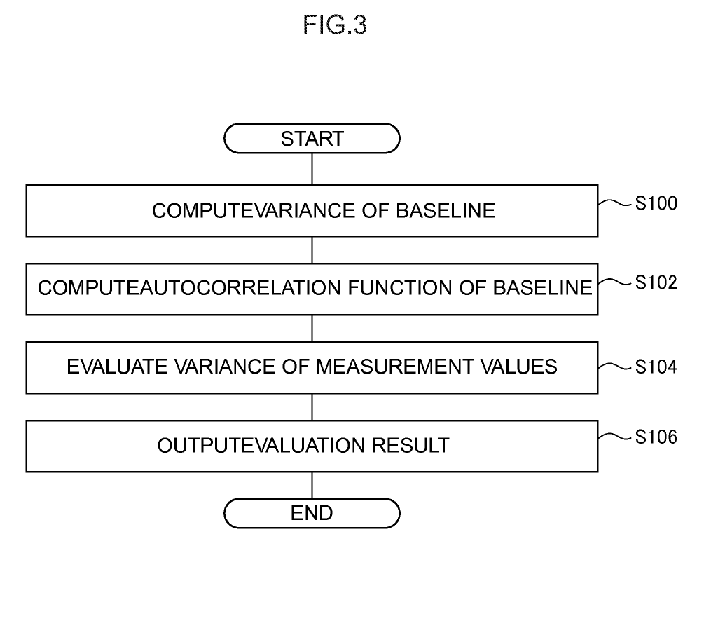

Explanation next follows regarding operation of the measurement precision evaluation device 100 according to the first exemplary embodiment of the present invention. The measurement precision evaluation device 100 executes the measurement precision evaluation processing routine illustrated in FIG. 3 when the baseline of the instrumental output is received in the input section 10.

First, at step S100, the calculation section 22 calculates the variance σ_{Y}² of the baseline Y(t) based on the baseline Y(t) of the instrumental output received by the input section 10. Then, at step 102, the calculation section 22 calculates the autocorrelation function ρ_{Y}(i) (i=1, . . . , k) of the baseline at lag i based on the baseline Y(t) of the instrumental output received by the input section 10, and based on the variance σ_{Y}² of the baseline Y(t) calculated at step S100 above.

At step S104, the precision evaluation section 24 evaluates the variance Var[A_{c}(k)] of the measurement values based on the variance σ_{Y}² of the baseline calculated at step S100 above, and based on the autocorrelation function ρ_{Y}(i) of the baseline calculated at step S102 above, according to Equation (2) above.

At step S106, the variance Var[A_{c}(k)] of the measurement values evaluated at step S104 above is output by the output section 90.

As explained above, the measurement precision evaluation device according to the first exemplary embodiment enables the precision of the measurement values of the instrumental output to be evaluated with high precision.

Explanation next follows regarding a second exemplary embodiment. Note that since the configuration of the measurement precision evaluation device of the second exemplary embodiment is similar to that of the first exemplary embodiment, the same reference numerals are appended thereto, and detailed explanation thereof is omitted.

Outline of Second Exemplary Embodiment

The present exemplary embodiment proposes an approach for evaluating measurement precision in instrumental analyses under the assumption of stationarity. The approach is a specific theory based on a first order autoregressive (AR(1)) process plus white noise. Consequently, the approach can cover the FUMI theory.

Measurement Precision for an AR(1) Process Plus White Noise

In the FUMI theory, the baseline noise, Y(t), is described as

Y(t)=r(t)+w(t), (3)

where r(t) is an AR(1) process; its definition is given by equation (4) and w(t) is white noise with zero mean (E[w(t)]=0) and finite, constant variance (Var[w(t)]=σ_{w}²). By the definition of white noise, w(t) and w(s) are not correlated, i.e., Cov[w(t), w(s)]=0 if t≠s.

As discussed by MacGregor and Harris (MacGregor, J. F.; Harris, T. J. Journal of Quality Technology. 1993, 25, 106-118.), the classical assumption that Y(t)=c+w(t) with a constant, c, and uncorrelated zero-mean error, w(t), is often quite unrealistic, especially for the continuous process industries. In fact, equation (3) is more realistic for continuous processes such as those in chemical industries where the white noise, w(t), is usually treated as sampling/measurement error and r(t) is a stochastic process (MacGregor, J. F.; Harris, T. J. Journal of Quality Technology. 1993, 25, 106-118.).

In the original FUMI theory (Hayashi, Y. and Matsuda, R. Analytical Chemistry. 1994, 66(18), 2874-2881.), it is assumed that r(0)=0. Under this assumption, the variance of r(t) increases with increasing t and then this process, r(t), is not stationary. Here, we start to develop a theory under the conditions of (weakly) stationary processes by assuming that the AR(1) process takes the form:

r(t)−μ=φ(r(t−1)−μ)+m(t), (4)

where E[r(t)]=μ and m(t) is white noise with E[m(t)]=0 and Var[m(t)]=σₘ². The random process of equation 4 is sometimes called a linear Markov process (Priestley, M. B. Spectral analysis and time series. Academic Press: London, 1981, 14-15 and 117.). From Box and Jenkins (Box, G. E. P.; Jenkins, G. M. Time series analysis: forecasting and control; Holden-Day: San Francisco, 1976, 56-58.), when the dependence parameter, φ, of the AR(1) process satisfies the condition |φ|<1, r(t) is stationary.

Substituting equation (3) for equation (1), we can obtain

$${A}_{c} ( k ) = {\sum }_{t = 1}^{k} r ( t ) - kr ( 0 ) + {\sum }_{t = 1}^{k} w ( t ) - kw ( 0 ) . \qquad ( 5 )$$

Using equation (4), we can write the first and second terms of equation (5) as

$${\sum }_{t = 1}^{k} r ( t ) - kr ( 0 ) = μ ( 1 - φ ) ( 1 + … + {φ}^{k - 1} ) + r ( 0 ) ( φ + … + {φ}^{k} - k ) + ( 1 + … + {φ}^{k - 1} ) m ( 1 ) + … + m ( k ) \qquad ( 6 )$$

If φ≈1, the first and second terms of equation (6) can be neglected and

$${\sum }_{t = 1}^{k} r ( t ) - kr ( 0 ) \approx ( 1 + … + {φ}^{k - 1} ) m ( 1 ) + ( 1 + … + {φ}^{k - 2} ) m ( 2 ) + … + m ( k ) . \qquad ( 7 )$$

Equation (7) is of the same form as equations (14a) and (14b) in reference (Hayashi, Y. and Matsuda, R. Analytical Chemistry. 1994, 66(18), 2874-2881.), where r(0) is assumed to be zero. In this case, the variance of r(t) is zero at t=0 and increases according to the equation

$$Var [ r ( t ) ] = \frac{1 - {φ}^{2 t}}{1 - {φ}^{2}} {σ}_{m}^{2} for t \geq 0. \qquad ( 8 )$$

Note that the corresponding equation (equation (15) in reference (Hayashi, Y. and Matsuda, R. Analytical Chemistry. 1994, 66(18), 2874-2881.)) is not correct.

Since the purpose of this section is to derive the variance of A_{c}(k) in equation (5), we need to consider the variance and covariance of Y(t). Using equation (3), we obtain

σ_{Y}²=Var[Y(t)]=σᵣ²+σ_{w}², (9)

where σᵣ²=Var[r(t)]. If |σ|<1, σᵣ² is given as

$${σ}_{r}^{2} = \frac{{σ}_{m}^{2}}{1 - {φ}^{2}} . \qquad ( 10 )$$

(Box, G. E. P.; Jenkins, G. M. Time series analysis: forecasting and control; Holden-Day: San Francisco, 1976, 56-58.)

Note that if |φ|<1 and t→∞, equation (8) is equivalent to equation (10). From Woodward et al. (Woodward, W. A.; Gray, H. L.; Elliott, A. C. Applied Time Series Analysis. CRC Press:Boca Raton, 2012, 18-19 and 85.), we then can develop the covariance as

$$\begin{matrix}\begin{matrix}Cov [ Y ( t ) , Y ( t + τ ) ] = Cov [ r ( t ) , r ( t + τ ) ] \\ = {σ}_{r}^{2} {φ}^{τ} ,\end{matrix} & ( 11 )\end{matrix}$$

where φ^{τ} is the autocorrelation of r(t) at lag τ(≧1). From equations (9) and (11), the autocorrelation function of Y(t) is given by

$${ρ}_{Y} ( τ ) = \frac{{φ}^{τ} {σ}_{r}^{2}}{{σ}_{r}^{2} + {σ}_{w}^{2}} , \qquad ( 12 )$$

where τ≧1. Based on equations (3)-(7), the objective equation takes the form:

$$Var [ {A}_{c} ( k ) ] = {σ}_{r}^{2} [ \frac{k - 2 φ - k {φ}^{2} + 2 {φ}^{k + 1}}{{( 1 - φ )}^{2}} + {k}^{2} - 2 k \frac{φ ( 1 - {φ}^{k} )}{1 - φ} ] + ( k + {k}^{2} ) {σ}_{w}^{2} . \qquad ( 13 )$$

Equation (13) corresponds to equation (19) in the original paper introducing the FUMI theory (Hayashi, Y. and Matsuda, R. Analytical Chemistry. 1994, 66(18), 2874-2881.). However, although these two equations look similar, they are stochastically different since equation (13) abides by the stationarity assumption but the other does not. Because of the zero level in equation (1), the assumption that μ=0 is unnecessary for the derivation of the objective equations (equations (2) and (13)). Taking equations (6) and (7) into account, we can understand that the FUMI theory can be included as a special case in the present theory described by equation (13).

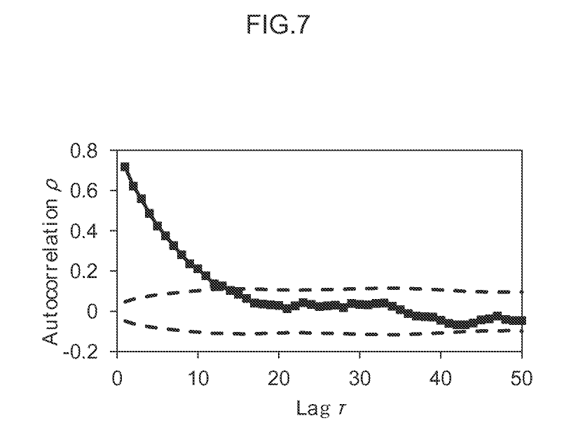

For the second exemplary embodiment, Equation (13) requires the parameters, φ, σᵣ and σ_{w}, for the uncertainty evaluation. To estimate φ, we can use the relationship: φ=ρ_{Y}(2)/ρ_{Y}(1) (see equation (12)). More generally, an estimate of φ can be made as:

$$\hat{φ} = \frac{{\sum }_{i = 1}^{J} [ {\hat{ρ}}_{Y} ( i + 1 ) / {\hat{ρ}}_{Y} ( i ) ]}{J} , \qquad ( 16 )$$

where J is an integer, e.g., J=3. The sample autocorrelations of FIG. 7 are calculated by equation (16). Using equations (9) and (12) with τ=1, we can estimate

$${\hat{σ}}_{r} = {\hat{σ}}_{Y} \sqrt{\frac{{\hat{ρ}}_{Y} ( 1 )}{\hat{φ}}} . \qquad ( 17 )$$

Using equation (9) again, we can estimate

\hat{σ}_{w}=\sqrt{\hat{σ}_{Y}²−\hat{σ}ᵣ²}. (18)

Derivation of Equation (13)

Since r(t) and w(t) are uncorrelated of each other and w(t) is white noise, the variance of the measurement error (equation (5)) takes the form:

$$Var [ {A}_{c} ( k ) ] = Var [ {\sum }_{t = 1}^{k} r ( t ) ] + {k}^{2} Var [ r ( 0 ) ] - 2 k Cov [ {\sum }_{t = 1}^{k} r ( t ) , r ( 0 ) ] + ( k + {k}^{2} ) {σ}_{w}^{2} . \qquad ( B .1 )$$

By equation (7) of reference (Zhang, N. F. Metrologia. 2006, 43, S276-S281.), the first term of the right side of equation (B.1) can be written as

$$Var [ {\sum }_{t = 1}^{k} r ( t ) ] = \frac{k - 2 φ - k {φ}^{2} + 2 {φ}^{k + 1}}{{( 1 - φ )}^{2}} {σ}_{r}^{2} . \qquad ( B .2 )$$

The second term of equation (B.1) takes the form:

Var[r(0)]=σᵣ². (B.3)

From equation (11), the third term of equation (B.1) can be described as:

$$\begin{matrix}Cov [ {\sum }_{t = 1}^{k} r ( t ) , r ( 0 ) ] = {σ}_{r}^{2} {\sum }_{t = 1}^{k} {φ}^{r} \\ = \frac{φ ( 1 - {φ}^{k} )}{1 - φ} {σ}_{r}^{2} .\end{matrix} \qquad ( B .4 )$$

Thus, using equations (B.1)-(B.4), we can obtain the objective equation (equation (13)):

$$\begin{matrix}Var [ {A}_{c} ( k ) ] = \frac{k - 2 φ - k {φ}^{2} + 2 {φ}^{k + 1}}{{( 1 - φ )}^{2}} {σ}_{r}^{2} + {k}^{2} {σ}_{r}^{2} - \\ 2 k \frac{φ ( 1 - {φ}^{k} )}{1 - φ} {σ}_{r}^{2} + ( k + {k}^{2} ) {σ}_{w}^{2} \\ = [ \frac{k - 2 φ - k {φ}^{2} + 2 {φ}^{k + 1}}{{( 1 - φ )}^{2}} + {k}^{2} - 2 k \frac{φ ( 1 - {φ}^{k} )}{1 - φ} ] \\ {σ}_{r}^{2} + ( k + {k}^{2} ) {σ}_{w}^{2}\end{matrix} . \qquad ( B .5 )$$

Configuration of Measurement Precision Evaluation Device According to Second Exemplary Embodiment

Next, in the measurement precision evaluation device 100 according to the second exemplary embodiment, the calculation section 22 calculates the variance σ_{Y}² of the Y(t) of the baseline, and the autocorrelation function ρ_{Y}(i) (i=1, . . . , k) of the baseline at lag i, based on the baseline Y(t) of the instrumental output received by the input section 10, and calculates a dependence parameter φ representing the strength of autocorrelation in a first order autoregressive process using the autocorrelation function ρ_{Y}(i) of the calculated baseline, according Equation (16).

The calculation section 22 also calculates the variance σᵣ² of the first order autoregressive process based on an autocorrelation function ρ_{Y}(1) of the baseline, the dependence parameter φ, and the standard deviation σ_{Y} of the baseline Y(t), according to Equation (17) above. The calculation section 22 calculates the variance σ_{w}² of white noise based on the variance σ_{Y}² of the baseline Y(t) and the variance σᵣ² of the first order autoregressive process, according to Equation (18) above.

The precision evaluation section 24 evaluates the variance Var[A_{c}(k)] of the measurement values based on the parameter φ calculated by the calculation section 22, the variance σᵣ² of the first order autoregressive process, and the variance σ_{w}² of the white noise, according to Equation (13) above.

The variance Var[A_{c}(k)] of the measurement values evaluated by the precision evaluation section 24 is output by the output section 90.

Operation of Measurement Precision Evaluation Device According to Second Exemplary Embodiment

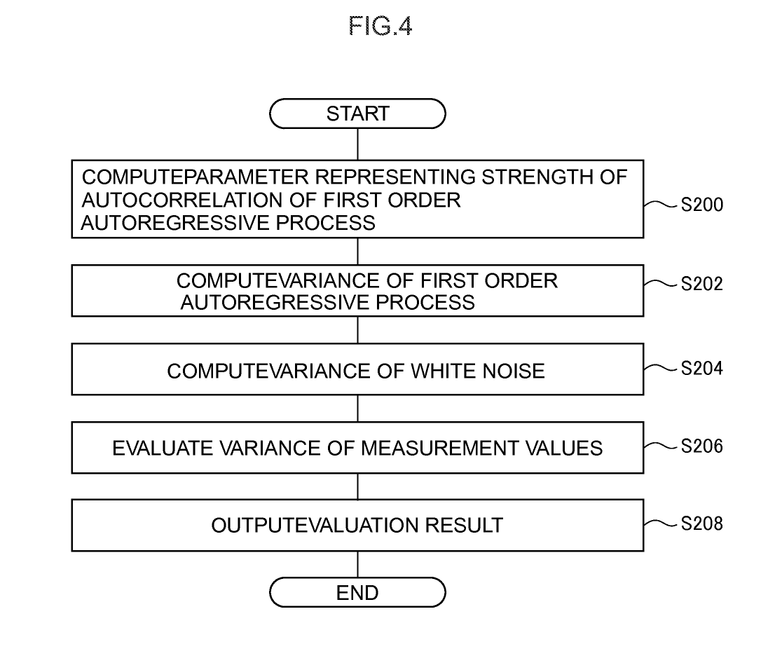

Explanation next follows regarding operation of the measurement precision evaluation device 100 according to the second exemplary embodiment of the present invention. The measurement precision evaluation device 100 executes the measurement precision evaluation processing routine illustrated in FIG. 4 when the baseline of the instrumental output is received in the input section 10.

First, at step S200, the calculation section 22 calculates the variance σ_{Y}² of the baseline Y(t), and the autocorrelation function ρ_{Y}(i) (i=1, . . . , k) of the baseline at lag i, based on the baseline Y(t) of the instrumental output received by the input section 10. The calculation section 22 uses the autocorrelation function ρ_{Y}(i) of the calculated baseline to calculate the parameter φ representing the strength of autocorrelation of the first order autoregressive process, according Equation (16) above.

Then, at step S202, the calculation section 22 calculates the variance σᵣ² of the first order autoregressive process based on the autocorrelation function ρ_{Y}(l) of the baseline, the parameter φ, and standard deviation σ_{Y} of the baseline Y(t), obtained at step S200 above, according to Equation (17) above.

At step S204, the calculation section 22 calculates the variance σ_{w}² of the white noise based on the variance σ_{Y}² of the baseline Y(t), and the variance σᵣ² of the first order autoregressive process, according to Equation (18) above.

At step S206, the precision evaluation section 24 evaluates the variance Var[A_{c}(k)] of the measurement values based on the parameter φ, the variance σᵣ² of the first order autoregressive process, and the variance σ_{w}² of the white noise, calculated at steps S200 to S204 above, according to Equation (13) above.

At step S208, the variance Var[A_{c}(k)] of the measurement values evaluated at step S206 above is output by the output section 90.

As explained above, the measurement precision evaluation device according to the second exemplary embodiment enables the precision of the measurement values of the instrumental output to be evaluated with high precision.

### EXAMPLES

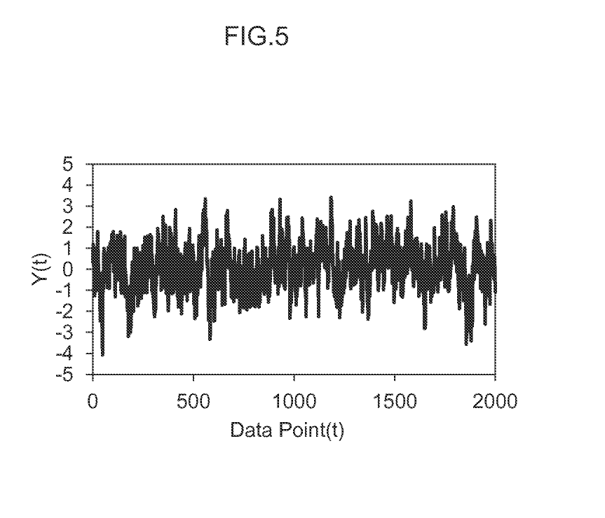

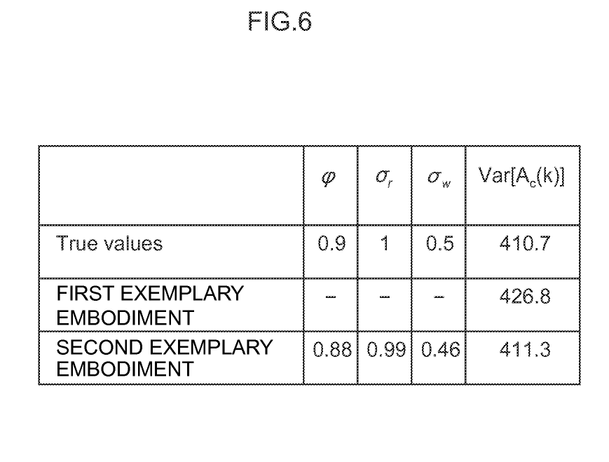

As mentioned above, in the scenario under discussion here, the variance of measurements (see equation (1)) over the background noise without signal can be substituted for the variance of measurements with signal. To illustrate the two approaches for doing this proposed above (equations (2) and (13)), we use a simulated data set generated from an AR(1) plus white noise process as Y(t) (equations (3) and (4)). FIG. 5 demonstrates the simulated time series, Y(t), with φ=0.9, μ=0, σᵣ²=1, and σ_{w}²=0.25 as the process parameters. Substituting these values of φ, σᵣ² and σ_{w}² for equation (13), we can obtain the true value of the measurement variance, Var[A_{c}(k)]=410.7 for the given value of k assumed here, k=20 (see FIG. 6).

In practical situations, however, the process parameters necessary for equations (2) and (13) are unknown and thus need to be estimated from the observable time series, Y(t) (t=1, . . . , n). Equation (2) includes the variance of Y(t), autocorrelation at lag i, and the width of the signal, k. The process variance, σ_{Y}², is estimated in the usual manner (Zhang, N. F. Proceedings of Section of Physical and Engineering Sciences of American Statistical Society. 2002, 3951-3954.)

$${\hat{σ}}_{Y}^{2} = \frac{{\sum }_{t = 1}^{n} {[ Y ( t ) - \overline{Y} ]}^{2}}{n - 1} , \qquad ( 14 )$$

where Y̅ is the sample mean (=[Y(1)+ . . . +Y(n)]/n). The autocorrelations can be substituted for by the sample autocorrelations (Woodward, W. A.; Gray, H. L.; Elliott, A. C. Applied Time Series Analysis. CRC Press:Boca Raton, 2012, 18-19 and 85.):

$${\hat{ρ}}_{Y} ( i ) = \frac{{\sum }_{t = 1}^{n - i} [ Y ( t ) - \overline{Y} ] [ Y ( t + i ) - \overline{Y} ]}{( n - i ) {\hat{σ}}_{Y}^{2}} . \qquad ( 15 )$$

FIG. 7 shows the sample autocorrelation resulting from the simulated data set of FIG. 5 with the corresponding approximate 95% confidence bands. The sample autocorrelations of FIG. 7 are calculated according to equation (15). In practice, the value of k also can be determined empirically from information about the signal shape. The estimates for the process parameters necessary for the uncertainty evaluation, Var[A_{c}(k)], are listed in FIG. 6.

The estimate of the measurement variance based on equations (16)-(18), Var[A_{c}(k)]=411.3, is closer to the true value of 410.7 than that based on equation (2), which produced Var[A_{c}(k)]=426.8 (see FIG. 6).

### DISCUSSION

The prerequisites of our approach to estimate the precision or standard deviation of measurements in instrumental analyses are: (i) the baseline noise can be approximated by a stationary process; and (ii) the baseline noise is the predominant source of measurement uncertainty. The prerequisites seem reasonable based on experimental evidence from a range of applications, especially for those in which the sample concentrations are near the detection limit.

If the baseline noise can be modeled as the sum of AR(1) and white noise random processes (equations (3) and (4)), the uncertainty evaluation (equation (13)) can be quite effective. The process parameters, φ, σᵣ, and σ_{w} in equation (13) can be estimated based on equations (16)-(18). For estimation of the sample autocorrelations (see FIG. 7), another approach is also possible with the aid of the non-linear least-squares fitting of theoretical models to observed power spectra⁸ or sample autocorrelations (Hayashi, Y.; Matsuda, R.; Poe, R. B.; J. Chromatogr. A. 1996, 722, 157-167.).

The approach of equation (2) is more flexible than that of equation (13), since no model of noise is assumed. As long as the observed time series can be considered stationary, equation (2) applies. FIG. 6 shows that the result of equation (13) is closer to the true value than that of equation (2), possibly due to the known noise model. However, its true superiority (or lack thereof) cannot be discussed, until a thorough examination has been carried out using Monte-Carlo simulation or an extensive series of applications using experimental data. This subject will be the target of a future study.

Of course, model-based methods for evaluation of measurement precision (here, using equation (2) and (13)) have advantages and disadvantages in practice. For example, Kotani et al. selected the optimum instrumental conditions among a large number of candidates, e.g., column types, mobile phase compositions, flow rates, etc. in liquid chromatography with electrochemical detection (Kotani, A.; Yuan, Y.; Yang, B.; Hayashi, Y.; Matsuda, R.; Kusu, F. Anal. Sci. 2009, 25, 925-929. Kotani, A.; Kojima, S.; Hayashi, Y.; Matsuda, R.; Kusu, F. J. Pharm. Biomed. Anal. 2008, 48, 780-787.). The optimization criterion used was the theoretically evaluated measurement relative standard deviation. In such situations, the use of this methodology can circumvent repeated experiments with real samples, helping to improve the global environment by saving natural resources.

Note that the present invention is not limited to the exemplary embodiments described above, and various modifications and applications are possible within a range not departing from the spirit of the invention.

For example, although explanation has been given of an example of a case in which the measurement precision evaluation device of the first exemplary embodiment calculates the autocorrelation function of the baseline based on the baseline of the instrumental output, there is no limitation thereto. The measurement precision evaluation device may calculate the autocovariance function of the baseline based on the baseline of the instrumental output.

Moreover, although explanation has been given of an example of a case in which the measurement precision evaluation device of the second exemplary embodiment uses the autocorrelation function of the baseline of the instrumental output to calculate the dependence parameter representing the strength of autocorrelation of the first order autoregressive process, there is no limitation thereto. The measurement precision evaluation device may use the autocovariance function of the baseline of the instrumental output to calculate the dependence parameter representing the strength of autocorrelation of the first order autoregressive process.

Moreover, although explanation has been given of an example of a case in which the measurement precision evaluation devices of the above exemplary embodiments evaluate the variance of the measurement values from the baseline, there is no limitation thereto. The measurement precision evaluation device may evaluate the standard deviation of the measurement values from the baseline.

Moreover, although explanation has been given in the present specification of exemplary embodiments in which a program is pre-installed, the program may be provided stored on a computer readable medium, and may be provided over a network.

All publications, patent applications and technical standards mentioned in the present specification are incorporated by reference in the present specification to the same extent as if the individual publication, patent application, or technical standard was specifically and individually indicated to be incorporated by reference.

1. A measurement precision evaluation device that, for a baseline of instrumental output containing a signal and noise considered to be a stationary process, evaluates a standard deviation or a variance of measurement values from the baseline, the measurement precision evaluation device comprising:
a calculation section that calculates an autocorrelation function or an autocovariance function of the baseline, and a statistical quantity of the baseline, based on the baseline of the instrumental output; and
a precision evaluation section that evaluates the standard deviation or the variance of the measurement values based on the autocorrelation function or the autocovariance function of the baseline, and based on the statistical quantity of the baseline, which are calculated by the calculation section.

2. The measurement precision evaluation device of claim 1, wherein:
the precision evaluation section evaluates the standard deviation or the variance of the measurement values according to the following equations:
$$Var [ {A}_{c} ( k ) ] = [ k + {k}^{2} - 2 {\sum }_{i = 1}^{k} {iρ}_{Y} ( i ) ] {σ}_{Y}^{2}$$
$${A}_{c} ( k ) = [ {\sum }_{t = 1}^{k} Y ( t ) ] - kY ( 0 )$$
wherein Var[A_{c}(k)] is the variance of the measurement values, Y(t) is an intensity of the baseline at time t of the instrumental output, ρ_{Y} (i) is the autocorrelation function of the baseline calculated by the calculation section, and σ_{Y}² is a variance serving as the statistical quantity of the baseline calculated by the calculation section.

3. A measurement precision evaluation device that, for a baseline of instrumental output including a signal and noise considered to be a random process combining white noise and a first order autoregressive process, evaluates a standard deviation or a variance of measurement values from the baseline, the measurement precision evaluation device comprising:
a calculation section that uses an autocorrelation function or an autocovariance function of the baseline to calculate a parameter representing a strength of autocorrelation of the first order autoregressive process, a variance of the first order autoregressive process, and a variance of the white noise, based on the baseline of the instrumental output; and
a precision evaluation section that evaluates the standard deviation or the variance of the measurement values based on the parameter, the variance of the first order autoregressive process, and based on the variance of the white noise, which are calculated by the calculation section.

4. The measurement precision evaluation device of claim 3, wherein the calculation section:
uses the autocorrelation function or the autocovariance function of the baseline to calculate the parameter representing the strength of autocorrelation of the first order autoregressive process based on the baseline of the instrumental output;
calculates the variance of the first order autoregressive process based on the autocorrelation function or the autocovariance function of the baseline, the parameter, and the statistical quantity of the baseline; and
calculates the variance of the white noise based on the statistical quantity of the baseline, and based on the variance of the first order autoregressive process.

5. The measurement precision evaluation device of claim 3, wherein:
the precision evaluation section evaluates the standard deviation or the variance of the measurement values according to the following equations:
$$Var [ {A}_{c} ( k ) ] = {σ}_{r}^{2} [ \frac{k - 2 φ - k {φ}^{2} + 2 {φ}^{k + 1}}{{( 1 - φ )}^{2}} + {k}^{2} - 2 k \frac{φ ( 1 - {φ}^{k} )}{1 - φ} ] - ( k + {k}^{2} ) {σ}_{w}^{2}$$
$${A}_{c} ( k ) = [ {\sum }_{t = 1}^{k} Y ( t ) ] - kY ( 0 )$$
wherein Var[A_{c}(k)] is the variance of the measurement values, Y(t) is an intensity of the baseline at time t of the instrumental output, φ is the parameter calculated by the calculation section, σᵣ² is the variance of the first order autoregressive process calculated by the calculation section, and σ_{w}² is the variance of the white noise calculated by the calculation section.

6. The measurement precision evaluation device of claim 3, wherein:
the calculation section calculates the parameter representing the strength of autocorrelation of the first order autoregressive process according to the following equation
$$φ = \frac{{\sum }_{i = 1}^{J} [ {ρ}_{Y} ( i + 1 ) / {ρ}_{Y} ( i ) ]}{J}$$
wherein J is a freely selected integer, and ρ_{Y}(i) is an autocorrelation function found from the observed baseline.

7. The measurement precision evaluation device of claim 3, wherein:
the calculation section calculates the variance of the first order autoregressive process according to the following equation
$${σ}_{r} = {σ}_{Y} \sqrt{\frac{{ρ}_{Y} ( 1 )}{φ}}$$
wherein σᵣ is a standard deviation of the first order autoregressive process, σ_{Y} is a standard deviation of the baseline, and φ is the parameter calculated by the calculation section.

8. The measurement precision evaluation device of claim 3, wherein:
the calculation section calculates the variance of the white noise according to the following equation
σ_{w}=\sqrt{σ_{Y}²−σᵣ²}
wherein σ_{w} is a standard deviation of the white noise, σ_{Y} is a standard deviation of the baseline, and σᵣ is a standard deviation of the first order autoregressive process.

9. A measurement precision evaluation method that, for a baseline of instrumental output including a signal and noise considered to be a stationary process, evaluates a standard deviation or a variance of measurement values from the baseline, the measurement precision evaluation method comprising:
calculating an autocorrelation function or autocovariance function of the baseline, and a statistical quantity of the baseline, based on the instrumental output; and
evaluating the standard deviation or the variance of the measurement values based on the calculated autocorrelation function or the calculated autocovariance function of the baseline, and based on the calculated statistical quantity of the baseline.

10. A measurement precision evaluation method that, for a baseline of instrumental output including a signal and noise considered to be a random process combining white noise and a first order autoregressive process, evaluates a standard deviation or a variance of measurement values from the baseline, the measurement precision evaluation method comprising:
using an autocorrelation function or an autocovariance function of the baseline, calculating a parameter representing a strength of autocorrelation of the first order autoregressive process, a variance of the first order autoregressive process, and a variance of the white noise, based on the baseline of the instrumental output; and
evaluating the standard deviation or the variance of the measurement values based on the calculated parameter, the calculated variance of the first order autoregressive process, and the calculated variance of the white noise.

11. A computer readable medium storing a program causing a computer to execute a process for evaluation of measurement precision, the process comprising:
for a baseline of instrumental output including a signal and noise considered to be a stationary process, calculating an autocorrelation function or autocovariance function of the baseline, and a statistical quantity of the baseline, based on the baseline of the instrumental output; and
evaluating a standard deviation or a variance of measurement values based on the calculated autocorrelation function or the calculated autocovariance function of the baseline, and based on the calculated statistical quantity of the baseline.

12. A computer readable medium storing a program causing a computer to execute a process for evaluation of measurement precision, the process comprising:
for a baseline of instrumental output including a signal and noise considered to be a random process combining white noise and a first order autoregressive process, calculating a parameter representing a strength of autocorrelation of the first order autoregressive process, a variance of the first order autoregressive process, and a variance of the white noise, based on the baseline of the instrumental output, using an autocorrelation function or an autocovariance function of the baseline; and
evaluating a standard deviation or a variance of measurement values based on the calculated parameter, the calculated variance of the first order autoregressive process, and the calculated variance of the white noise.
